(19) United States
(12) Patent Application Publication
(10) Pub. No.: US 2004/0043219 A1
(43) Pub. Date: Mar. 4, 2004

(54) Pattern forming method for carbon nanotube, and field emission cold cathode and method of manufacturing the cold cathode

(76) Inventors: Fuminori Ito, Tokyo (JP); Yuko Okada, Tokyo (JP); Yoshinori Tomihari, Tokyo (JP); Kazuo Konuma, Tokyo (JP); Akihiko Okamoto, Tokyo (JP)

Correspondence Address: Choate Hall & Stewart, Patent Group, Exchange Place, 53 State Street, Boston, MA, 02109-2804, US

(21) Appl. No.: 10/433,382

(22) PCT Filed: Nov. 26, 2001
(86) PCT No.: PCT/JP01/10276

(30) Foreign Application Priority Data
Nov. 29, 2000 (JP) 2000-362395

(51) Int. Cl. B32B 9/00

(52) U.S. Cl. 428/408

(57) ABSTRACT

Upon wet etching and thereby patterning carbon nanotubes (106) by a transfer method, a solution for dissolving a binder used in the transfer method as a solution used for the wet etching is used, and the carbon nanotubes (106) tangled with each other are rubbed off with a cloth-like substance (112) upon the wet etching. Furthermore, upon patterning the carbon nanotubes (106) using a dry etching method, a metal film or a film made of a substance resistant to damage upon the dry etching and causing no damage to the carbon nanotubes (106) when removed is used as a mask. A fine carbon nanotube pattern having an excellent flatness is formed.

### TECHNICAL FIELD

The present invention relates to a method for patterning a carbon microstructure material containing carbon nanotubes, a field emission cold cathode employing the carbon nanotubes, a method for fabricating the field emission cold cathode, and a flat image display device employing the field emission cold cathode.

### BACKGROUND ART

Carbon nanotubes are known to be chemically and mechanically tough and become a focus of attention as an electron source material as well. A carbon nanotube is a cylinder or a plurality of nested cylinders, rolled into a tubular shape, of a graphitic carbon atom face having a thickness of few atomic layers, being an ultra-fine tubular substance having an outer diameter of the order of nanometers and a length of the order of micrometers. Those having one cylinder are called single-wall nanotubes, while those having a plurality of nested cylinders are called multi-wall nanotubes.

Known as a method for producing carbon nanotubes are an arc discharge method, a CVD method, and a laser ablation method. The carbon nanotube is produced in the form of soot which is mixed with impurities such as fine particles of carbon other than the carbon nanotube. In particular, the single-wall nanotube and the multi-wall nanotube to be formed by the arc discharge method require a catalytic metal in the process of production, for example, such as iron, nickel, cobalt, yttrium, or lanthanum, thus taking the form of soot containing fine particles of metal as well. Here, the impurities such as fine particles of carbon and the fine particles of metal such as catalytic metal occurring in the process of production are called nanoparticles.

In the process of refining carbon nanotubes by the arc discharge method, the surface of catalytic metal fine particles is first coated with amorphous carbon at the time of discharge, and a plurality of nanotubes grow from the coated amorphous carbon with the nanotubes tangled with each other. After having been formed, the catalytic metal is covered over the surface thereof with a thin film of amorphous carbon. Furthermore, fine carbon particles are also formed during the discharge with some of them adhered to nanotubes, and in some cases, a plurality of nanotubes are bonded to each other via the fine carbon particle. As such, the fine particles cause the nanotubes to be tangled with each other.

It is possible to relatively easily remove these nanoparticles from the carbon nanotubes produced by the arc discharge method. The fine carbon particles can be generally removed in an oxygen ambient in a short period of time without causing deterioration of the nanotubes, for example, in an atmospheric ambient at about 450° C. in 15 minutes. This is because fine carbon particles having many carbon atoms loosely bonded to each other readily react with oxygen and thus the fine carbon particles are selectively oxidized and removed.

Furthermore, in this process, the amorphous carbon covering the surface of catalytic metal is also removed, thereby causing the catalytic metal to be exposed to the surface. After the heat treatment, the catalytic metal such as cobalt, yttrium, iron, nickel, or lanthanum can be removed by being treated, e.g., in hydrochloric acid of about 35% for two hours or more. Since the thin film of amorphous carbon covering the surface is removed through the heat treatment, an acid treatment can be employed for etching. Such a carbon nanotube from which nanoparticles are removed is called a refined carbon nanotube.

To use the carbon nanotube as an electron source, it is necessary to form the sooty carbon nanotubes as a carbon nanotube film on a substrate. In particular, to use it as an electron source for a field emission display (FED), it is necessary to form a fine pattern of the carbon nanotube film.

A FED employing carbon nanotubes has a gate electrode, placed above a cathode using a carbon nanotube film, for drawing electrons, and further above it, placed is an anode which is provided with red, green, and blue phosphor. Such a structure as including the cathode, gate, and anode is called a triode structure. A voltage is applied to the gate, and electrons are thereby drawn from the carbon nanotubes serving as the cathode to hit the anode allowing the phosphors to emit colored beams of light. However, by forming an insulating film on the cathode, further forming a cathode hole, and forming a gate electrode around the hole on the insulating film, it is possible to form a structure in which no electrons are injected into the gate. Furthermore, the FED is provided with a plurality of the triode structures, which are operated separately in principle to represent images. To this end, the carbon nanotube film needs to be formed in a fine pattern and operated electrically independently. Incidentally, since the anode electrode is formed separately on the opposing piece of glass of the FED, the triode structure hereinafter refers mainly to a structure which includes the cathode made up of carbon nanotubes, the insulating film, and the gate electrode.

As a method for forming a film of carbon nanotubes in a predetermined pattern, disclosed in Japanese Patent Laid-Open Publication No. 2000-203821 is a method by which one patterned into a predetermined pattern on a substrate using an adhesive tape is placed in a solution in which carbon nanotubes are dispersed, the solution is allowed to naturally evaporate to thereby deposit the carbon nanotubes on the substrate, and thereafter the adhesive tape is peeled off, thereby providing a carbon nanotube film of the predetermined pattern. More specifically, a copper plate to which an adhesive tape is adhered in the predetermined pattern is placed in a beaker in conjunction with the solution in which the carbon nanotubes are dispersed, the solution is allowed to evaporate to thereby deposit the carbon nanotubes on the copper plate, and finally, the adhesive tape is peeled off to thereby form the pattern.

In Japanese Patent Laid-Open Publication No. Hei 6-252056, disclosed is a method by which carbon nanotubes dispersed in a resist are applied to a substrate and exposed to light and developed in a predetermined pattern, thereafter a fixer material is adhered to the carbon nanotubes to thereby fix the carbon nanotubes to the substrate, and the resist is further lifted off to thereby allow only the carbon nanotubes and the fixer material to remain.

Reported in SID'99 Digest, p1137 (1999) and SID'00 Digest, p329 (2000) is a method for forming carbon nanotubes on a cathode metal trace by screen printing.

Described in Feng-Yu Chuang, SID00 Digest, p329 (2000) is a method for forming, as an electron source of a FED, slurry containing carbon nanotubes and a binder by screen printing.

According to the method for a CNT layer shown in Japanese Patent Laid-Open Publication No. 2000-203821, since carbon nanotubes are tubular substances of extremely high aspect ratios with several nanometers to tens of nanometers in diameter and several micrometers in length and thus tangled with each other in a complicated manner, there was a problem that the carbon nanotubes deposited by natural evaporation on the substrate to which an adhesive tape was affixed were tangled, peeled off, or dislodged at their ends, thus making it impossible to form a neat pattern. That is, since the carbon nanotubes are several micrometers in length, the carbon nanotubes on the substrate and the carbon nanotubes on the adhesive tape are tangled with each other during deposition upon the natural evaporation. Thus, peeling off the adhesive tape caused the carbon nanotubes on the substrate to be stripped away together or the carbon nanotubes to remain on the portion from which the adhesive tape was peeled off. Furthermore, since the carbon nanotube film formed by natural evaporation causes the solvent not to evaporate uniformly, it was difficult to obtain a flat carbon nanotube film.

According to the method disclosed in Japanese Patent Laid-Open Publication No. Hei 6-252056, since the carbon nanotubes are dispersed in the resist for patterning and thus the content of carbon nanotubes cannot be made so high in order to prevent underexposure, there was a problem of causing a reduced density of the carbon nanotubes in the resulting film.

In the method, reported in SID'99 Digest, p1137 (1999) and SED'00 Digest, p329 (2000), for forming a pattern by screen printing, since mixing with a solvent and a binder is required to form ink to conduct the screen printing, this method thus caused the density of the carbon nanotubes in the resulting film to be reduced as in Japanese Patent Laid-Open Publication No. Hei 6-252056 described above. Furthermore, it is difficult to uniformly evaporate the solvent in the ink upon the evaporation thereof, thus raising a problem of causing fine irregularities to occur in the carbon nanotube film due to cavities occurring at portions that became rid of the solvent, for example.

By the screen printing method, described in Feng-Yu Chuang, SID00 Digest, p329 (2000), it was possible to form a pattern of the order of several hundreds of micrometers, but difficult to form a fine pattern of several tens of micrometers or less.

For example, a transfer method for forming CNTs in the form of film is described in Science, Vol. 268 (1995), page 845 and Science, Vol. 270 (1995), page 1175. In this transfer method, a CNT suspension having CNTs dispersed in a solution is filtered with a ceramic filter having a pore size of 0.2 μm, and then the reverse side of a film of CNTs remaining on the filter is pressed onto a substrate, only the filter being stripped away thereafter. This allows a thin film containing CNTs to be formed on the substrate.

On the other hand, described in Japanese Patent Application No. Hei 11-260249 is a method for fabricating a field emission cold cathode by mixing CNTs and a conductive paste to form a CNT layer by screen printing. Furthermore, described in Japanese Patent Application No. Hei 11-145900 is a method for fabricating a field emission cold cathode by dispensing, coating (spin coating), or spraying a suspension of CNT's in ethanol or a liquid mixture of CNTs and a binder (resist or water glass) to thereby form a CNT layer. Still Furthermore, described in page 1776 of Applied Physics Letter Vol. 176 (2000) is a method for fabricating a field emission cold cathode by forming Ni on a substrate and then forming a highly aligned CNT layer thereon by CVD (Chemical Vapor Deposition).

Upon applying the CNT layer formed as described above to a display, the CNT layer is used in the cathode (emitter) as an electron source. In a diode structure with an anode electrode and a phosphor disposed in close proximity thereto, as described in Appl. Phys. Letters, Volume 72, p.2912, 1998, for example, a voltage of 300V is applied between the anode electrode and the emitter which oppose each other, and the electrons emitted from the emitter are allowed to hit and excite the phosphor on the anode electrode side to emit light, thereby displaying characters or the like on the display.

FIG. 12 shows an example of an image display device in a triode structure. In this triode structure, an emitter 214b using CNTs is employed for a field emission cold cathode, with a gate electrode layer 208 (grid electrode) disposed between the emitter 214b and an anode electrode 212. A conductive substrate or a conductive layer 205 is formed on a glass substrate 206, a CNT layer 214 is deposited on the conductive layer 205, and the gate electrode layer 208 is formed on the CNT layer 214 via a gate insulating layer 207. Furthermore, a gate opening 209 penetrating the gate electrode layer 208 and the gate insulating layer 207 allows a portion of the CNT layer 214 to be exposed to form the emitter 214b. The anode electrode 212 is disposed above and spaced a predetermined distance from the glass substrate 206 containing such as the CNT layer 214 and the gate electrode layer 208, with the space therebetween being maintained under vacuum.

In the triode structure, a negative potential is applied to the CNT layer 214 while a positive potential is applied to the anode electrode 212 and the gate electrode layer 208, respectively, thereby allowing electrons to be emitted from the emitter 214b exposed within the gate opening 209 toward the anode electrode 212. The field emission cold cathode having this triode structure can control the amount of electrons emitted from the emitter 214b by means of the electric field (gate voltage) between the gate electrode layer 208 and the emitter 214b. To obtain uniform and highly stable emission current from the emitter surface at a low gate voltage, it is indispensable to increase the physical and chemical stability of the emitter surface and the density of micro-projections which are the field concentration points.

To fabricate a flat image display device such as FEDs using the triode structure, an insulating film is formed on a CNT layer and an opening is then formed in the insulating film using an etching solution or an etching gas or the like, wherein those CNTs that stand upright near the surface of the CNT layer may disappear due to the influence of the etching solution or the etching gas, thereby impairing good characteristics of electric field concentration.

A CNT layer fabricated according to a prior art fabrication method is shown in FIG. 13. In this fabrication method, a liquid mixture having CNTs 215 dispersed in a binder solution is coated onto the conductive layer 205 on the surface of the substrate 206, and a CNT layer 216 is formed while the adhesion between the substrate 206 side and the CNTs 215 is being enhanced. With this method, for example, most CNTs 215 on the surface of the CNT layer 216 lie down toward the substrate surface due to the viscosity and the surface tension of the binder solution or are buried in the binder, thereby impairing their upright states and making it extremely difficult to realize uniform emission characteristics at low voltages.

The binder is often composed mainly of an insulating material such as resist water glass, and acrylic resin. When the surface of the CNT layer 216 is coated with this insulating material, the surface barrier of electrons is substantially increased upon emission of the electrons, thereby significantly reducing the emission efficiency. This may enhance the adhesiveness between the substrate 206 and the CNT layer 216; however, an emitter having CNTs 215 not aligned upright cannot make full use of the advantage of being provided with the CNT layer 216.

Furthermore, although electrons are emitted in a vacuum in principle, emitted electrons hitting the anode electrode will cause gases adsorbed on the anode electrode surface to be re-emitted into the vacuum due to the electron bombardment elimination. Furthermore, emitted electrons colliding with residual gases in the vacuum may cause the residual gases to be ionized. In the cases of a degraded vacuum or a large amount of degases from the anode, the reaction takes place locally in succession, resulting in discharge. This may cause CNTs to fly apart to the gate electrode and the anode electrode, resulting in damage to the element.

The phenomenon is often observed when the adhesiveness between the substrate and the CNT layer is weak. For example, since the transfer method described in page 845 of Science, Vol. 268 (1995) employs no binder, the good emission characteristics typical of CNTs can be easily obtained, but the CNT layer is vulnerable to damage upon discharge due to the weak adhesiveness.

Furthermore, in the method for dispensing the suspension of CNTs in ethanol as described in Japanese Patent Application No. Hei 11-145900, the ethanol is completely removed upon baking, thus reducing the adhesiveness of the CNTs and making it difficult to obtain stable emission characteristics. Still Furthermore, the CNT layer formed by CVD, as described in page 1776 of Applied Physics Letter Vol. 176 (2000), provides an excellent alignment property but a weak adhesion to the substrate, thereby making the CNT layer vulnerable to damage upon generation of local discharge.

Additionally, an expensive piece of equipment is required for the deposition of the CNT layer by CVD, thus causing an increase in costs.

Furthermore, the CVD requires a high-temperature process and is difficult for large areas, thus being unsuitable for the fabrication of a flat image device with a large screen.

### DISCLOSURE OF THE INVENTION

The present invention was developed in view of the above circumstances. It is therefore an object of the present invention to provide a method which makes it possible to facilitate the formation of a microscopic pattern of carbon nanotube film and enables the formation of a carbon nanotube pattern having an excellent flatness, an excellent pattern end shape, and improved reliability in insulation between the elements.

It is another object of the present invention to provide a field emission cold cathode which is enhanced in adhesiveness between the substrate and the CNT layer, uniform while using the CNT layer, and capable of generating highly uniform stable emission current and providing good emission characteristics, as well as a fabrication method for fabricating the field emission cold cathode having such characteristics.

It is another object of the present invention to provide a flat image display device which incorporates therein the field emission cold cathode.

In a first aspect, the present invention provides methods for patterning carbon nanotubes shown below:

(1) A method for patterning carbon nanotubes by removing the carbon nanotubes via a mask formed in a predetermined pattern, the carbon nanotubes being adhered to a substrate or a substrate having a thin film coated on at least part of a surface thereof, the carbon nanotubes containing a binder and tangled with each other, the method characterized in that a solution for dissolving the binder is used to remove the carbon nanotubes, and the tangled carbon nanotubes are rubbed off;

(2) The method for patterning carbon nanotubes according to (1), wherein a cloth-like substance is dampened with the solution used for the removal to rub the carbon nanotubes with the cloth-like substance, thereby removing the carbon nanotubes and rubbing off the carbon nanotubes with the cloth-like substance;

(3) The method for patterning carbon nanotubes according to (1) or (2), wherein the mask is made of metal, glass, or ceramic;

(4) The method for patterning carbon nanotubes according to (1) to (3), wherein the carbon nanotubes are nanotubes containing nanoparticles;

(5) A method for patterning carbon nanotubes by removing through a first dry etching method part of the carbon nanotubes adhered to a substrate or a substrate having a thin film coated on at least part of a surface thereof, the method characterized in that as a mask for patterning the carbon nanotubes, a metal film or a film made of a substance resistant to damage upon the first dry etching and causing no damage to the carbon nanotubes upon removing the mask is used;

(6) A method for patterning carbon nanotubes characterized in that the first dry etching method is a method of burning in an oxygen ambient;

(7) The method for patterning carbon nanotubes according to (5) or (6), wherein the metal film is an aluminum film, a titanium film, a gold film, a molybdenum film, a tungsten film, or a silver film;

(8) The method for patterning carbon nanotubes according to (5) or (6), wherein the film made of the substance resistant to damage upon the first dry etching and causing no damage to the carbon nanotubes upon removal is a silicon dioxide film or an aluminum oxide film;

(9) The method for patterning carbon nanotubes according to (5) to (8), wherein the carbon nanotubes are single-wall nanotubes or multi-wall nanotubes;

(10) The method for patterning carbon nanotubes according to (9), wherein the single-wall nanotubes or the multi-wall nanotubes are refined nanotubes having nanoparticles removed.

(11) The method for patterning carbon nanotubes according to (1) to (9), wherein the carbon nanotubes are nanotubes containing nanoparticles and nanoparticles remaining between patterns of the carbon nanotubes are removed by lifting off at least part of the thin film;

(12) The method for patterning carbon nanotubes according to (5) to (9), wherein the carbon nanotubes are nanotubes containing nanoparticles and the nanoparticles remaining between patterns of the carbon nanotubes are removed by a second dry etching method different from the first dry etching method;

(13). The method for patterning carbon nanotubes according to (12), wherein the second dry etching method is any one of sputtering etching, chemical etching, reactive etching, reactive sputtering etching, ion beam etching, and reactive ion beam etching, and removes a catalytic metal constituting at least part of the nanoparticles; and

(14) The method for patterning carbon nanotubes according to (1) to (13), wherein a carbon nanotube film is formed by a screen printing method, a spray method, or a transfer method.

The method for patterning carbon nanotubes according to the a first aspect of the present invention makes it possible to easily form a fine film pattern of carbon nanotubes tangled with each other and for example, allow the transfer method to form a carbon nanotube pattern which has an excellent flatness and which provides an excellent shape to the end portions of the pattern and improved reliability in insulation between elements.

Here, the carbon nanotubes (CNTs) may be formed in either a single-wall structure or a multi-wall structure.

The CNT having the multi-wall structure is chemically more robust, while the CNT of the single-wall structure can be chemically etched more easily. Accordingly, the single-wall CNT makes the process time shorter and allows a high throughput. The single-wall CNT is richer in flexibility, and therefore can be formed into a denser film with a denser surface portion. For this reason, upon forming a metal film or an insulating film on the surface thereof, it is possible to form a thin film having an excellent covering property. Particularly, in the case of a metal film used as an etching mask, this allows pinholes to be hardly formed and etching to cause less damage to suppress nonuniform emission, thereby allowing for finer patterning. In particular, for a field emission display or the like employing a fine emitter that requires a pixel size of 800 μm or less, the single wall is more preferable.

On the other hand, the multi-wall CNT has a larger nanotube diameter and a larger number of emission points, and as a result, is resistant to ion damage even when subjected to ion damage. Accordingly, it is possible to use it for a long period of time even in a high ion energy ambient. For this reason, the multi-wall CNT is preferable for a large display which has a large structure and to which a high voltage is applied, such as a fluorescent display tube and a microwave tube. In particular, for a field emission display or the like employing an emitter that requires a pixel size of 800 μm or more, the multi-wall structure is preferable.

In a second aspect, the present invention provides a field emission cold cathode including an emitter formed on a substrate and containing a plurality of carbon nanotubes (CNTs), and allowing a predetermined voltage to be applied to the emitter to emit electrons from a surface of the emitter,

the field emission cold cathode characterized in that the emitter has a stacked structure made of a successively stacked binder layer and CNT layer containing CNTs bonded by the binder layer.

In the field emission cold cathode according to the second aspect of the present invention, since the binders and CNTs are formed in a film independently and a clean CNT surface can be maintained without allowing the binders to directly affect the CNT surface, it is possible to enhance the adhesion between the substrate and the CNT layer and facilitate the formation of the upright alignment of the CNTs on the CNT layer surface. This makes it possible to provide a field emission cold cathode that realizes stable and highly uniform emission characteristics at a low voltage. Incidentally, the “upright alignment” means the state of alignment in which the tip portion of the CNTs in the CNT layer is aligned at an angle of 50 degrees or less relative to the normal to the substrate. Although the upright alignment is enhanced due to an electrostatic force resulting from the application of an electric field, the upright alignment as referred to herein is a “state after the enhancement”.

Here, preferably, two or more of the stacked structure are stacked successively. In this case, even when the uppermost CNT layer is subjected to damage, the underlying CNT layer appears on the surface to serve as a new electron emission source, thereby providing an effect of hardly degrading the characteristics. That is, the stacked structure of the CNT layer and the binder layer may be formed once, successively twice, or successively more than twice. The more the number of times of stacking the structure, the higher the stability of the characteristics against damage becomes.

Here, it is preferable that a gate insulating layer and a gate electrode layer are formed in that order on the CNT layer, a surface of the CNT layer is exposed from an opening penetrating both the gate electrode layer and the gate insulating layer, and a different voltage is applied to each of the gate electrode layer and the emitter. In this case, obtained is an effect of being capable of emitting high emission current at a low gate voltage.

More specifically, the binder layer can be set to a thickness of 0.01 to 1 μm, and the CNT layer can be set to a thickness of 0.1 to 5 μm, respectively. In this case, since the CNT layer is securely adhered to the substrate, obtained is an effect of providing good emission characteristics without causing damage to the element.

Furthermore, the field emission cold cathode described above can be applied to a flat image display device, thereby providing a flat image display device having good emission characteristics.

In a third aspect, the present invention provides a method for fabricating a field emission cold cathode characterized by forming a conductive layer on a substrate,

forming a stacked CNT layer by stacking a binder layer and a CNT layer containing a plurality of carbon nanotubes (CNTs) in that order on the conductive layer,

forming a gate insulating layer and a gate electrode layer in that order on the stacked CNT layer, and

forming an opening by removing the gate electrode layer and the gate insulating layer by etching to expose a surface of the stacked CNT layer within the opening.

In the method for fabricating a field emission cold cathode according to the third aspect of the present invention, since forming the binder and CNTs in a film independently makes it possible to provide a structure that allows for maintaining a clean CNT surface without allowing the binder to directly affect the CNT surface, it is possible to enhance the adhesion between the substrate and the CNT layer and obtain a CNT layer having CNTs aligned upright on the CNT layer surface. This provides a field emission cold cathode that realizes stable and highly uniform emission characteristics at a low voltage.

Here, the step of forming the stacked CNT layer is preferably performed twice or more successively. In this case, it is possible to increase the adhesion of the CNT layer to the substrate.

Furthermore, it is preferable to have the step of baking the CNT layer and the binder layer prior to the step of forming the gate insulating layer and the gate electrode layer. In this case, obtained is an effect of further increasing the adhesion of the CNT layer to the substrate.

In a fourth aspect, the present invention provides a method for fabricating a field emission cold cathode characterized by

forming a conductive layer on a substrate,

forming a gate insulating layer and a gate electrode layer successively in that order on the conductive layer,

removing the gate electrode layer and the gate insulating layer by etching to form an opening and exposing the conductive layer within the opening, and

covering the gate electrode layer excluding the opening with a mask material and spraying a binder material and carbon nanotubes (CNTs) in that order onto the conductive layer through the mask material and the opening to form a stacked CNT layer.

In the method for fabricating a field emission cold cathode according to the fourth aspect of the present invention, forming the binder and CNTs in a film independently makes it possible to provide a structure that allows for maintaining a clean CNT surface without allowing the binder to directly affect the CNT surface. This makes it possible to obtain a CNT layer having a high adhesion to the substrate and CNT aligned upright on the CNT layer surface, thus providing a field emission cold cathode that realizes stable and highly uniform emission characteristics at a low voltage.

Here, the step of forming the stacked CNT layer is preferably performed twice or more successively. In this case, it is possible to increase the adhesion of the CNT layer to the substrate.

Furthermore, it is also a preferred mode that the gate insulating layer includes a first and a second insulating layer each having an opening and stacked successively, and the opening of the first insulating layer is formed to be larger in diameter than the opening of the gate electrode layer. In this case, an effect of suppressing the adhesion of the CNTs to the surface around the gate opening portion is obtained.

Preferably, the opening of the mask material is formed to be smaller in diameter than the opening of the gate insulating layer. In this case, an effect of further suppressing the adhesion of the CNTs to the surface around the gate opening portion is obtained.

Furthermore, it is also a preferred form that the mask material is formed to satisfy the following equation:

t/d>1,

where d is a diameter of the opening of the mask material and t is a thickness of the mask material. In this case, an effect of further suppressing the adhesion of the CNTs to the surface around the gate opening portion is obtained.

Furthermore, since the evaporation of solvent components in a CNT suspension can be accelerated by heating the substrate upon forming the CNT layer, the CNTs are hardly subjected to the surface tension of the solvent. That is, the upright alignment of the surface CNTs is accelerated.

### BRIEF DESCRIPTION OF THE DRAWINGS

FIG. 1A to FIG: 1D are sectional views each sequentially illustrating a process step of a fabrication method according to a first embodiment of the present invention;

FIG. 2A to FIG. 2I are sectional views each sequentially illustrating a process step of a fabrication method according to a second embodiment of the present invention;

FIG. 3A to FIG. 3H are sectional views and perspective views each sequentially illustrating a process step of a fabrication method according to a third embodiment of the present invention;

FIG. 4 is a perspective view illustrating the main portion of a field emission cold cathode fabricated by a method according to a fifth embodiment of the present invention;

FIG. 5A to FIG. 5E are sectional views each sequentially illustrating a process step of a fabrication method according to the fifth embodiment of the present invention;

FIG. 6 is a sectional view illustrating the step of forming a CNT layer in detail in the fabrication method according to the fifth embodiment;

FIG. 7 is a graph showing the results of measurements of emission current densities with an anode electrode disposed on a stacked CNT layer;

FIG. 8A to FIG. 8F are sectional views each illustrating a field emission cold cathode fabricated by a method according to a sixth embodiment of the present invention;

FIG. 9 is a sectional view illustrating a modified example of the sixth embodiment, showing a field emission cold cathode with the diameter of an opening in a first insulating layer formed to be larger than the diameter of an opening on a second insulating layer;

FIG. 10 is a sectional view illustrating another modified example of the sixth embodiment, showing a field emission cold cathode which is provided with a shielding effect by expanding the central portion of the opening in one insulating layer;

FIG. 11 is a graph showing the emission characteristics of a field emission cold cathode fabricated by the method according to the fifth and sixth embodiments;

FIG. 12 is a sectional view illustrating an example of a prior art field emission cold cathode; and

FIG. 13 is a sectional view illustrating a problem with the prior art field emission cold cathode.

### BEST MODES FOR CARRYING OUT THE INVENTION

First Embodiment

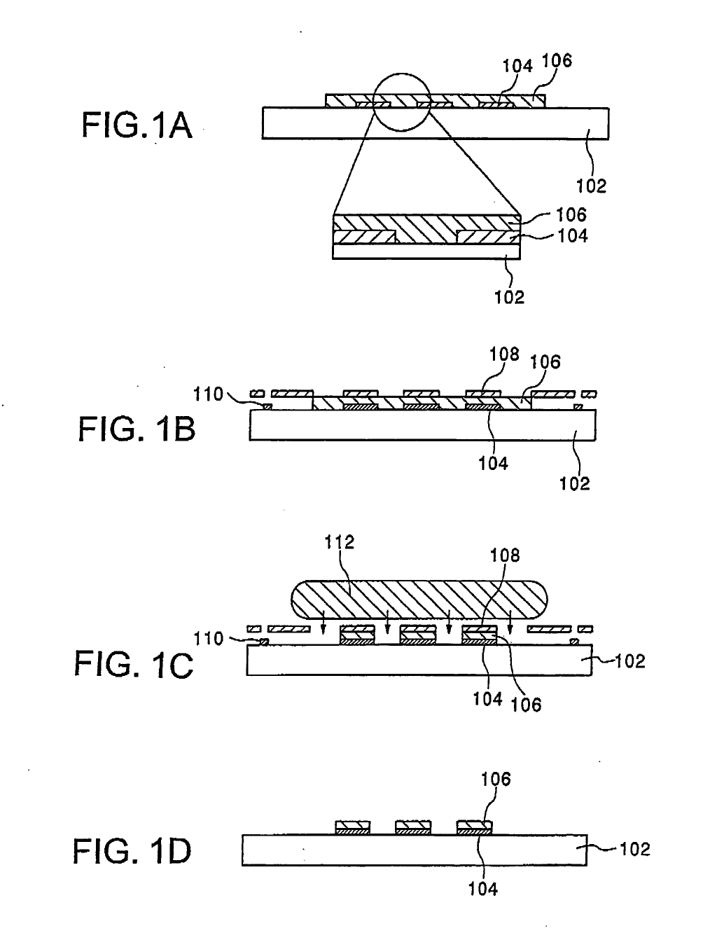

A method according to a first embodiment of the present invention will be described with reference to FIG. 1A to FIG. 1D. FIG. 1A shows a single-wall nanotube film 106 formed, for example, by the transfer method on conductive traces 104 formed on a substrate 102.

In the transfer method, ultrasonic waves or the like are first applied to disperse carbon nanotubes into a solvent. This allows the nanotubes to be formed into fine particles and split as well. Then, the nanotubes are poured onto a paper filter to be filtered by suction, thereby formed into a carbon nanotube thin film. Nitrocellulose or ethyl cellulose or the like is coated as a binder onto the substrate, and then the carbon nanotube film on the paper filter is placed upside down to be transferred onto the substrate. The paper filter is then removed to form a thin film. The surface of the carbon nanotube film is in contact with the surface of the paper filter and is therefore as flat as the surface of the paper filter.

In this carbon nano tube film, tubular carbon nanotubes of very high aspect ratios of several nanometers to several tens of nanometers in diameter and several micrometers in length and nanoparticles are tangled with each other in a complicated manner.

In this example, as shown in FIG. 1B, a mask 108 made of metal, glass, ceramic or the like is disposed so as to be aligned with the underlying conductive traces 104. Here, alignment marks 110 which are formed outside the carbon nanotube region are used for the placement of the mask, thereby making it possible to easily align the mask with the conductive traces.

Subsequently, as shown in FIG. 1C, a cloth-like substance 112, such as glass fibers, dampened with an etching solution, e.g., methyl ethyl ketone, for dissolving the binder components used to form the carbon nanotube film 106 is used to remove by rubbing the carbon nanotubes and the nanoparticles which are tangled with each other, thereby patterning a carbon nanotube film. Since the carbon nanotube film obtained by the transfer method is very dense, the portions covered with the mask will not be dissolved even by rubbing using the cloth-like substance dampened with the etching solution and remain adhered to the conductive traces. Shown in FIG. 1D is the shape of the patterned carbon nanotube film.

Although the transfer method was mentioned as a method of forming the carbon-nanotube film, the patterning of a carbon nanotube film formed using a method such as the screen printing method or the spray method may also be applicable. The spray method is a technique for spraying a liquid mixture to thereby form a CNT layer.

For a cellulose based adhering material such as nitrocellulose employed in the transfer method, a solvent, e.g., methyl ethyl ketone, which is highly volatile and can be easily removed from the film, is sucked during deposition, thereby allowing residual volatile substances to be removed. When an electric field is applied to the carbon nanotube film to emit electrons, residual gases are prevented from being ionized because the residual volatile substances are removed. This prevents abnormal discharge due to discharge and damage to the element resulting therefrom, thereby making it possible to extend the life of the display.

Furthermore, when compared with other deposition methods, the transfer method provides higher densities to the carbon nanotube film and makes the surface flatter because the surface having been in contact with a flat paper filter during the suction is employed as the upper surface. When an insulating film and a gate are deposited thereon, it is easier to form a stable triode structure in comparison with other methods. On the other hand, the printing method makes it possible to form a pattern at the time of printing by forming the pattern on a screen. However, a paste needs to be mixed, and lower densities of carbon nanotubes and coarser surfaces are provided when compared with the transfer method. An insulating film and a gate deposited thereon would make it difficult to form a stable triode structure. As described above, when the present invention is employed for the carbon nanotube film formed by the transfer method, it is possible to provide good element isolation and form a stable triode structure.

Furthermore, the carbon nanotubes and nanoparticles were removed using the cloth-like substance 112 such as glass fibers dampened with a solvent; however, it is also possible to remove them by other methods, e.g., by rubbing with a brush or the like while a solvent is being sprayed. However, the cloth-like substance is easily dampened with a highly volatile solvent and capable of being deformed according to a pattern and subjected to a pressure as well, and therefore preferable to remove a dense carbon nanotube film like a sample fabricated by the transfer method.

Furthermore, since an excessive force is also applied to the mask other than nanotubes upon rubbing, it is better to employ not a mask material such as resist or tape which is easily deformed or crushed but metal, glass, or ceramic. In particular, upon FED operation, an organic substance or the like separated and remaining in an emitter portion would cause gas emission, deterioration in the degree of vacuum, ionization of residual gases, and abnormal discharge due to discharge. Such problems will never be raised with metal, glass, and ceramic. In particular, metal can be formed into a thin film with its strength being maintained and is therefore most preferable.

This embodiment can also be applied to the refined carbon nanotube film. However, when refined nanotubes are rubbed with a cloth-like substance dampened with a solvent, those refined nanotubes containing the solvent are observed to be expanded and deformed. Accordingly, the end portion of the nanotubes rubbed swells and deforms, leading to deterioration in its pattern. In some cases, cracks may occur during drying. On the other hand, any expansion or deformation is hardly found in non-refined nanotubes. This is because the nanotubes are tangled with each other to form a sturdy film due to the presence of particles.

Accordingly, the non-refined nanotube is preferably lower in costs and provides less deterioration in patterned shape than the refined nanotube.

Second Embodiment

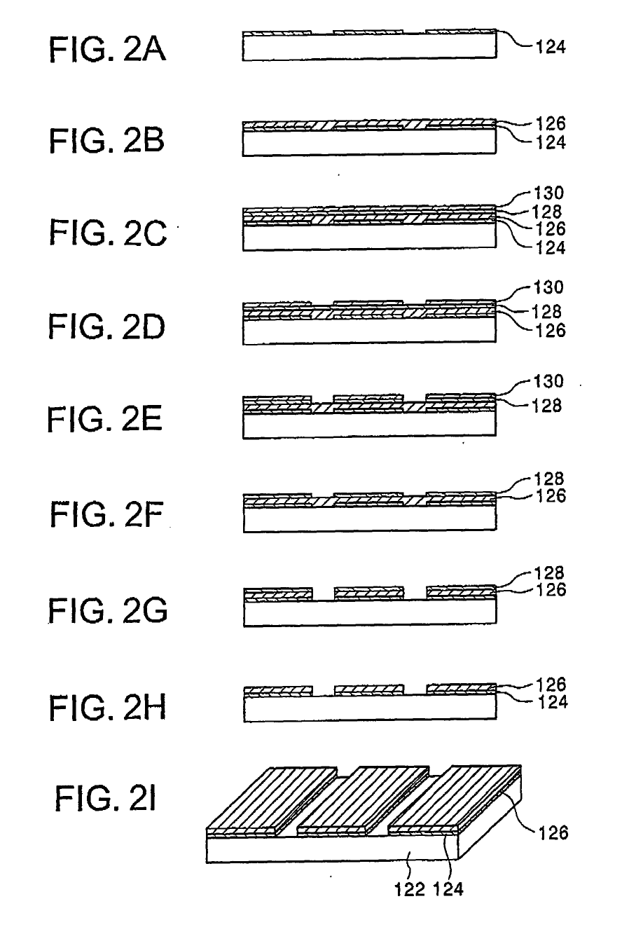

A method according to a second embodiment of the present invention will be described with reference to FIG. 2A to FIG. 215. FIG. 2A is a sectional view illustrating metal cathode traces 124 which are patterned in the shape of stripes on the glass substrate 102. For example, methods for forming the cathode traces include a method by which a metal film is formed on the entire surface of the glass substrate by a technique such as evaporation, sputtering, or CVD, a resist is coated and then exposed and developed into a strip-shaped pattern, then the metal film is etched, and thereafter the resist is stripped away.

Subsequently, as shown in FIG. 2B, multi-wall nanotubes, single-wall nanotubes formed by arc discharge using a catalytic metal, or single-wall nanotubes having the catalytic metal removed are mixed into an organic binder to form into a carbon nanotube film 126 on the entire substrate of FIG. 2A. For example, methods of forming the carbon nanotube film include the transfer method.

Subsequently, as shown in FIG. 2C, an aluminum film 128 that is to serve as a mask is formed on the carbon nanotube film 126 of FIG. 2B, and then a resist 130 is coated onto the aluminum film 128 for patterning.

Subsequently, as shown in FIG. 2D, the resist 130 is exposed and developed into the shape of stripes in alignment with the pattern of the cathode traces 124.

Subsequently, as shown in FIG. 2E, using the patterned resist 130 as a mask, the aluminum film 128 is etched.

Subsequently, as shown in FIG. 2F, the resist is stripped away.

Subsequently, as shown in FIG. 2G using dry etching equipment such as O₂ plasma ashing equipment, a carbon nanotube film exposed to the surface is burned and thereby removed. Here, the burning includes not only the case of increasing the temperature of a sample but also a method for oxidizing the sample with activated O₂ plasma and radicals without increasing the temperature of the substrate, or ashing.

Finally, as shown in FIG. 2H, the aluminum film on the carbon nanotube film 126 is removed by wet etching with phosphoric acid, particularly with heated phosphoric acid, thereby making it possible to pattern a carbon nanotube film on the cathode traces 124.

In comparison with a nanotube film before patterned, the patterned carbon nanotube film formed according to this embodiment was observed to have no microscopic variations by observation under an electron microscope and provided the same emission current, thus revealing that even the removal of the aluminum film caused no damage. FIG. 2I shows a perspective view illustrating the process of FIG. 21I.

Since the pattern of carbon nanotubes obtained according to this embodiment is formed by burning with the aluminum film employed as a mask, the carbon nanotubes at the pattern end portions are not tangled with each other, thus providing an excellent shape.

Incidentally, this embodiment was described using the O₂ plasma ashing, however, it is also possible to perform etching by other dry etching methods, for example, sputter etching, chemical etching, reactive etching, reactive sputter etching, ion-beam etching, or reactive ion-beam etching.

The gas etching or radical containing etching is chemical etching or reactive etching, and capable of removing carbon nanotubes or nanoparticles mainly composed of carbon using a reactive gas, such as oxygen or hydrogen, which is capable of reactively removing carbon. The carbon nanotubes, carbon nanoparticles, and amorphous carbon covering the surface of a catalytic metal have a carbon bond of six-carbon ring or a five-carbon ring structure. When compared with the carbon nanotubes, the carbon nanoparticles and the amorphous carbon covering the surface of the catalytic metal have an imperfect carbon bond of more five-carbon rings and are more likely to react with reactive gases.

Accordingly, to pattern carbon nanotubes containing carbon nanoparticles and amorphous carbon covering the surface of a catalytic metal, the gas etching or the radical containing etching is more effectively performed. Furthermore, the gas etching or the radical containing etching, which is the isotropic etching, allows the reactive gas to reach not only the surface of nanotubes being patterned but also the side wall of nanotubes and nanoparticles near the surface as well as the reverse surface to selectively react with carbon, thereby making it possible to quickly remove other than the catalytic metal. An additional process, discussed later, for removing only the catalytic metal makes it possible to pattern carbon nanotubes containing nanoparticles. Reaction products, e.g., in the case of oxygen, change to gases such as CO or CO₂ and thus will not re-adhere to the substrate, thereby raising no problem of contaminating the surface. In particular, the burning with oxygen is simple and preferable.

Now, the case of using an ionic sputtering effect will be discussed. In the second embodiment, those carbon nanotubes that are desired to remain during patterning are coated with aluminum by sputtering or by evaporation, however, in some cases, since the surface of the carbon nanotubes has large irregularities, the recessed portions cannot be sufficiently covered with the aluminum particularly inside thereof. When a reactive gas is used to continue etching for a long period of time, the gas reaches a portion, which is not sufficiently coated with a protective film, to etch the carbon nanotubes therefrom.

On the other hand, in the case of using etching by the ionic sputtering, the ion species travel strictly in straight lines and thus go into from the upper surface, thereby hardly causing damage to the carbon nanotubes located under the thick coated film. Furthermore, since the etching is anisotropic, the etching can be performed faithfully and vertically to a mask pattern. Therefore, this is preferable to remove a carbon nanotube film that does not contain nanoparticles particularly a catalytic metal and to form a fine pattern.

The ion beam etching and the reactive ion beam etching can be performed without a mask, however, it is necessary to modulate the beams, thus requiring process time per area. They are more suitable to a small display than a large-area display.

Incidentally, this embodiment showed an example in which an aluminum film was used as a mask upon the O₂ plasma ashing, however, a metal that will not cause any damage to the carbon nanotubes upon removal, for example, titanium, gold, molybdenum, tungsten, or silver may also be used. Titanium can be quickly removed by nitric acid, gold by aqua regia, molybdenum by thermal sulfuric acid or aqua regia, and tungsten by a liquid mixture of hydrofluoric acid and nitric acid. However, since performing the processing for a long period of time causes, although gradually, nitric acid, sulfuric acid, and hydrofluoric acid to degrade the carbon nanotubes, it is necessary to perform the processing under those conditions, especially at a temperature, a concentration, and a predetermined period of time which will not cause damage, particularly deterioration in emission for FEDs. At room temperature, the processing performed within one hour using a 65% nitric acid, a 90% sulfuric acid, a 45% hydrofluoric acid, or a mixture thereof can cause no damage. Aluminum is preferred to other metals because it is less expensive than other metals, provides an excellent coating state to the carbon nanotubes, in particular, a high coating ratio due to the dense crystal grains of aluminum, and allows no deterioration of the carbon nanotubes against phosphoric acid serving as an etching solution.

On the other hand, metals having a greater atomic weight provide less ion sputtering ratios, and are suitable as a mask material for dry etching which mainly provides the sputtering effect. In particular, gold, tungsten, and molybdenum are twice or more as resistant to sputtering as aluminum and titanium and hardly subjected to damage immediately under the mask, thus preferably removing carbon nanotubes that do not contain nanoparticles particularly a catalytic metal and preferably forming a fine pattern as well.

Furthermore, other than metals, it is also possible to use a substance, such as silicon dioxide or aluminum oxide, which is not subjected to damage in the O₂ plasma ashing and causes no damage to the carbon nanotubes upon removal.

In the case of metal, since it provides increased conductivity and can be used as a cathode electrode, no additional cathode electrode has advantageously to be formed. In the case of other than metal, particularly in the case of an insulating film, when a gate metal is coated directly or the insulating film and the gate metal are coated to form a triode structure, this can be used as an insulating layer between the gate metal and the cathode. In some cases, the additional formation of an insulating film can be eliminated, thereby making it possible to facilitate the process.

On the other hand, in this embodiment, the transfer method was described as a method for forming the carbon nanotube film of FIG. 2B, however, it is also possible to easily form a carbon nanotube film even using a method such as the screen printing method. However, although the transfer method provides a high density of nanotubes causing the nanotubes to tangle with each other, while other patterning methods cause their patterns to be peeled off or dislodged at their ends, thus making it impossible to form a neat pattern, the present invention makes it possible to form a flat surface and an excellent pattern as well as a fine pattern of several tens of micrometers or less.

On the other hand, when compared with the transfer method, the screen printing method and the spray method make it possible to easily form a thin film on the entire surface of a large-area display of 30 inches or more and are simple methods in the first embodiment, being suitable for a large display intended for home use. The second embodiment makes it possible to form a fine pattern and is suitable for the fabrication of a high-definition flat television or the like.

Furthermore, as shown in FIG. 2F, this embodiment includes the step of stripping off the resist on the aluminum film. However, even when the step of stripping off the resist is eliminated, the resist will also be simultaneously removed in the subsequently performed O₂ plasma ashing step. Accordingly, even when the step of stripping off the resist is eliminated, it is likewise possible to form a carbon nanotube pattern.

Third Embodiment

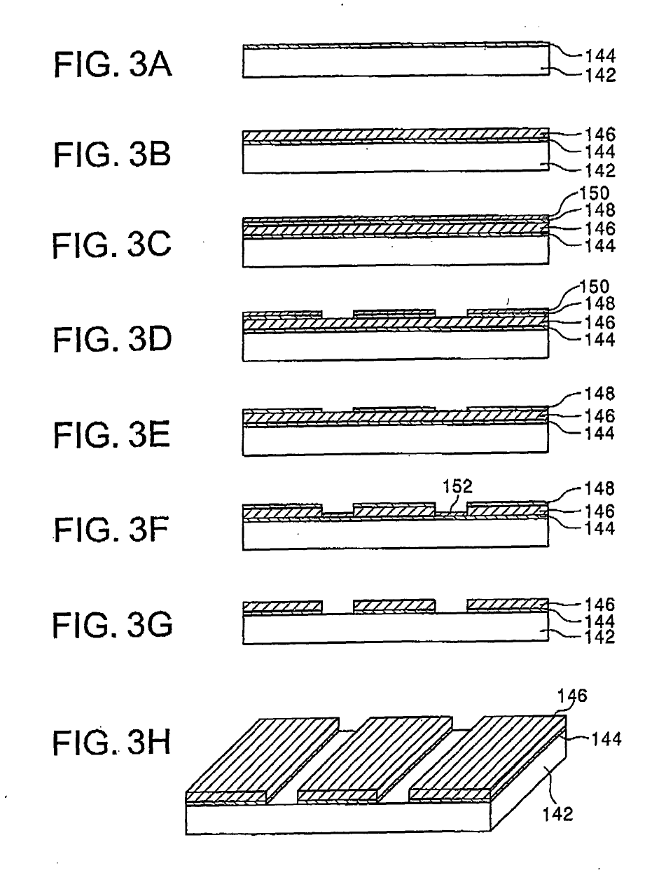

A third embodiment of the present invention will be described with reference to FIG. 3A to FIG. 3H. FIG. 3A illustrates a sectional view of a glass substrate 142, on the entire surface of which formed is a metal film 144 using a method such as evaporation, sputtering, or CVD.

Subsequently, as shown in FIG. 3B, single-wall nanotubes are mixed, for example, with an organic binder to be formed into a carbon nanotube film 146.

Subsequently, as shown in FIG. 3C, an aluminum film 148 serving as a mask is formed on the carbon nanotube film 146, and a resist 150 is subsequently coated onto the aluminum film.

Subsequently, as shown in FIG. 3D, the resist 150 is exposed and developed in the shape of stripes. Subsequently, with the resist used as the mask, the aluminum film 148 is etched.

Subsequently, as shown in FIG. 3E, the resist is stripped away.

Subsequently, using O₂ plasma ashing equipment, the carbon nanotube film 146 exposed to the surface of the substrate of FIG. 3E is burned and removed, thereby patterning a carbon nanotube film. For example, since the single-wall nanotubes include many impurities such as a catalytic metal, impurities 152 such as the catalytic metal remain on a portion which is not masked with the aluminum film, as shown in FIG. 3F. The residual impurities such as the catalytic metal may develop an electrical short circuit between the patterns, resulting in a malfunction for FEDs.

However, subsequent soaking under this state in an etching solution for the underlying metal allows the underlying metal to be etched with the patterned carbon nanotube film serving as a mask. At the same time, the impurities such as the catalytic metal are lifted off and removed.

In the case of the first embodiment, nanoparticles or trace amounts of carbon nanotubes may also remain even when rubbed under pressure using a cloth-like substance dampened sufficiently with an etching solution, however, subsequent soaking of the underlying metal in the etching solution causes the underlying metal to be etched with the patterned carbon nanotube film serving as the mask. At the same time, the nanoparticles are lifted off and removed.

Finally, the aluminum film used as the mask is etched, thereby simultaneously forming the pattern of the cathode traces and the carbon nanotube film as shown in FIG. 3G. FIG. 3H is a perspective view illustrating the step of FIG. 3G.

Since the carbon nanotube pattern obtained according to this embodiment is formed by burning with the aluminum film used as a mask, an excellent shape can be obtained without the carbon nanotubes tangled with each other at the pattern ends.

Incidentally, this embodiment showed such an example in which a mixture of single-wall nanotubes and an organic binder was formed as a carbon nanotube film, but can also be applied to the case where a mixture of multi-wall nanotubes or refined single-wall nanotubes and an organic binder is formed as a carbon nanotube film. In this case, without the impurities such as the catalytic metal shown in FIG. 3F being exposed, the underlying metal is etched with the patterned carbon nanotubes used as a mask to etch the aluminum film for mask use, thereby making it possible to simultaneously form the cathode traces and the carbon nanotube film, as shown in FIG. 3G, and advantageously facilitating the process when compared with the case of using a carbon nanotube film containing nanoparticles.

Fourth Embodiment

Now, a fourth embodiment will be described. In the third embodiment, as shown in FIG. 3F, when the O₂ plasma processing is performed on the carbon nanotubes containing carbon nanoparticles, the impurities 152 such as the catalytic metal remain in the non-masked portion. Subsequently after this, it is possible to replace the gas species to perform dry etching on the catalytic metal. The catalytic metals are iron, nickel, cobalt, yttrium, lanthanum or the like, and can be sputtered with ionic gases such as milling.

Furthermore, it is possible to improve reactivity using a reactive gas, in particular, a halogen-based gas, for example, such as chlorine, hydrochloric acid, boron tri-chloride, sulfur hexafluoride, or bromine hydride in order to remove the catalytic metal. Additionally, the ionic etching is more effective with reactive gas species such as radicals. The reactivity can be improved to accelerate reactions and sputtering can be performed with an ionic gas, thereby allowing reaction products to be removed from the surface.

Incidentally, when an aluminum film is used as a mask material as described in the third embodiment, the mask material such as resist which is selective relative to the catalytic metal may need to be changed or additionally patterned. However, when a metal having a greater atomic weight and resistant to sputtering, for example, such as gold, molybdenum, or tungsten is used instead of the aluminum film and adjusted to a thickness enough for the residual catalytic metal to be sufficiently resistant during the time of the sputtering being performed, no change in mask or the like is required and no additional steps are required, which is more preferable when compared with aluminum.

The aluminum film is removed when the aluminum film is used as it is, however, when the carbon nanotubes are suppressed in deterioration by shortening the time of their exposure, patterned carbon nanotubes are formed without an additional step of removing the aluminum film.

When iron, nickel, cobalt, yttrium, or lanthanum, serving as a catalytic metal, is removed using a reactive gas, particularly a halogen-based gas, the substrate can be effectively heated to thereby accelerate the removal. A halogen compound of the catalytic metals has a low vapor pressure at room temperature, however, it is possible to increase the vapor pressure by heating, thereby accelerating the removal.

Fifth Embodiment

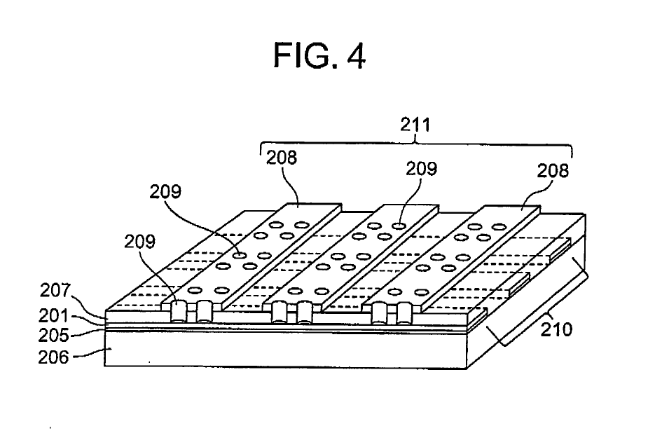

FIG. 4 is a perspective view illustrating the main portion of a field emission cold cathode fabricated by a method according to a fifth embodiment of the present invention. The CNTs constituting the emitter can be fabricated by the arc discharge method or the laser ablation method or the like, however, the CNTs according to this embodiment are fabricated using the arc discharge.

On a glass substrate 6, the field emission cold cathode has a plurality of stripe-shaped conductive layers 2 which extend in the right to left direction in FIG. 4 in parallel to each other and which have a thickness of 0.5 μm. There is deposited a CNT layer 201 having the same width and a thickness of 2 μm on each conductive layer 205 to form cathode (emitter) lines 10. Additionally, SOG (Spin On Glass), or polyimide, acrylic resin or the like is dispensed and applied (spin coated) to a thickness of 1.5 μm and 5 μm, respectively, so as to cover the entire surface of the glass substrate 206 containing the CNT layer 201, thereby being formed into a gate insulating layer 207. The gate insulating layer 207 having less thicknesses can drive emission at lower voltages, however, excessively less thicknesses may cause the surface of the insulating layer to reflect the shape of the shoulders of the underlying cathode lines 210 as they are, thus making it difficult to form gate lines 211. Accordingly, the gate insulating layer 207 was formed in 20 μm here.

On the gate insulating layer 207, stripe-shaped gate electrode layers 208 having a thickness of 0.5 μm extend in a direction orthogonal to the cathode lines 210 and in parallel to each other to form the gate lines 211. At the intersections of the cathode lines 210 and the gate lines 211, formed are gate openings 209 which constitute electron emitting portions and have a predetermined diameter (e.g., 50 μm), allowing the CNT layer 201 exposed to the gate openings 209 to constitute emitters.

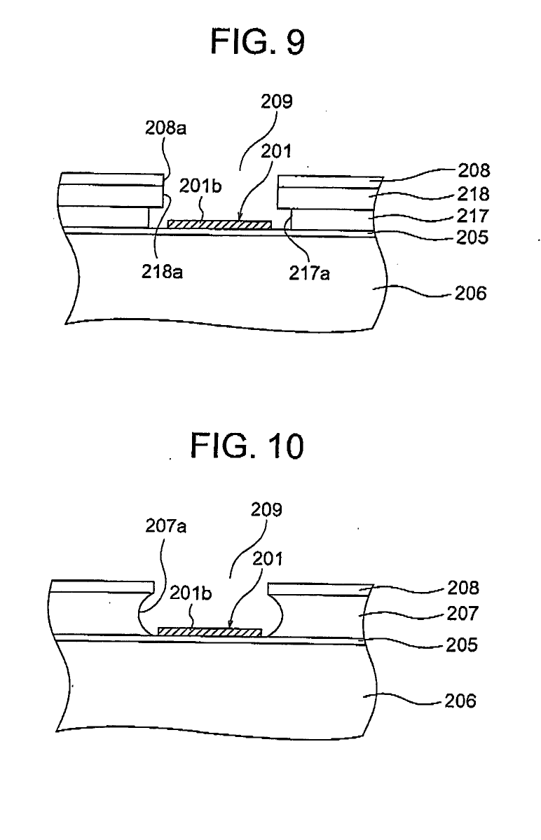

Above the glass substrate 206 on which the electron emitting portions are formed, an anode panel (see FIG. 9) onto which RGB (red, green, and blue) phosphors are applied is disposed opposite to the glass substrate 206 separated therefrom by a predetermined distance. This allows a flat image display device to be constituted which provides display operations by selectively applying voltages to the cathode lines 210 and the gate lines 211. Furthermore, the space between the glass substrate 206 and the anode panel is maintained under vacuum.

Here, the processing for manufacturing the CNTs contained in the CNT layer 201 by the arc discharge method will be described. First, a reactive container (not shown) is filled with a helium (He) gas at 66500 Pa (500 Torr) and two carbon bars (not shown) containing a catalytic metal are opposed to each other at each of their top ends to generate arc discharge between both the carbon bars. This allows a solid containing CNTs to be deposited on the surface of the carbon bar on the cathode side and on the inner wall of the reactive vessel, respectively. The arc discharge is performed, for example, by applying a voltage of 18V between both the carbon bars and allowing a current of 100A to flow.

In the solid deposited, contained are graphite particles having a diameter of about 10 to 100 nm, amorphous carbon, catalytic metal or the like in addition to the CNTs. The CNTs obtained here are single-layer nanotubes of a diameter of 1 to 5 nm, a length of 0.5 to 100 μm, and an average length of about 2 μm. The CNTs fabricated using not the arc discharge method but the laser ablation method also have the same size in principle as those fabricated by the arc discharge method.

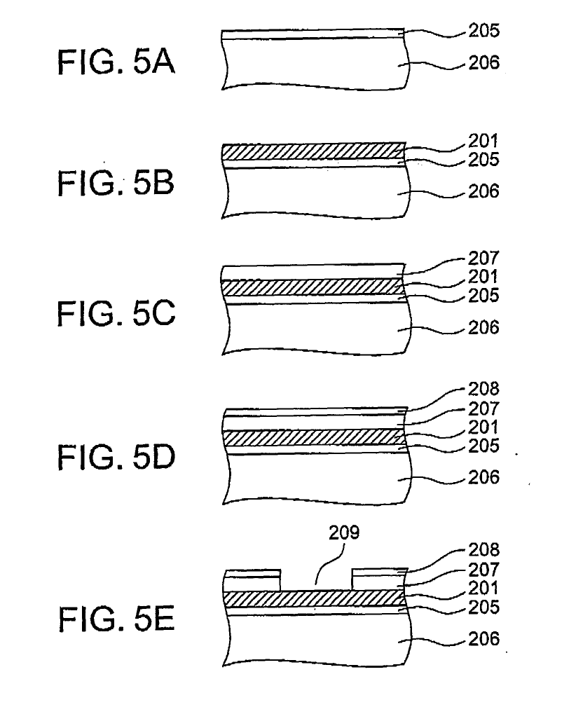

FIG. 5A to FIG. 5E sequentially illustrate the steps of a method for fabricating a field emission cold cathode according to this embodiment. As shown in FIG. 5A, the conductive layer 205 is formed on the glass substrate 206 by the chemical vapor deposition (CVD) method or the like, and then as shown in FIG. 5B, the CNT layer 201 having a stacked structure described later is formed on the conductive layer 205.

Subsequently, as shown in FIG. 5C, the gate insulating layer 207 of silicon oxide film or polyimide film or the like is deposited in a thickness of 20 μm. Additionally, as shown in FIG. 5D, aluminum is formed in a thickness of 0.5 μm on the gate insulating layer 207 as the gate electrode layers 208. Subsequently, as shown in FIG. 5E, part of the gate electrode layers 208 and the gate insulating layer 207 is removed by etching to form the gate openings 209.

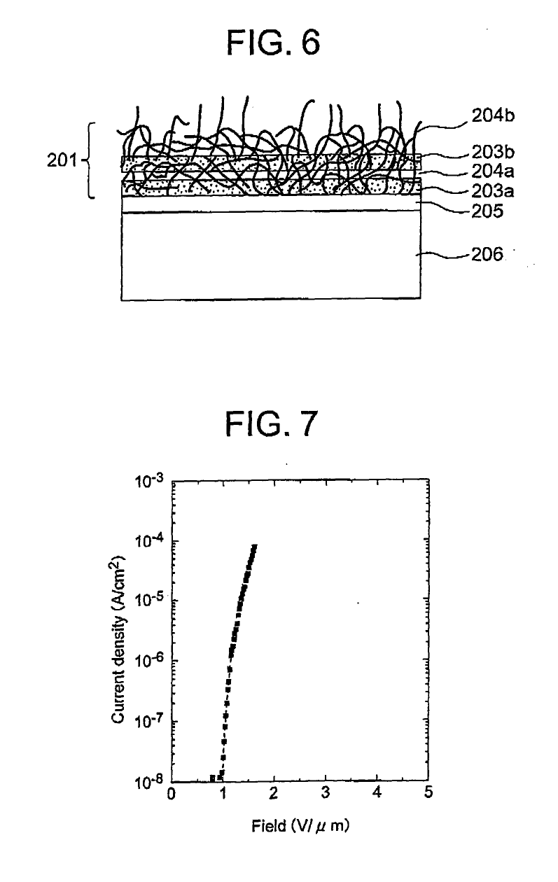

Here, the step of forming the CNT layer 201 is detailed in FIG. 6. First, a first binder layer 203a is formed to a thickness of 0.8 μm on the conductive layer 205 formed on the glass substrate 206. Immediately thereafter, a film of CNTs in a thickness of 2 μm is formed as a first CNT layer 204a on the first binder layer 203a. Furthermore, a second binder layer 203b and a second CNT layer 204b are sequentially deposited on the first CNT layer 204a in the same manner as described above, thereby allowing the second CNT layer 204b to be located at the uppermost layer.

Subsequently, the first and second binder layers 203a, 203b are baked to harden to form the stacked CNT layer 201, in which a number of CNTs are bonded by the first binder layer 203a under the first CNT layer 204a, while a number of CNTs are bonded by the second binder layer 203b under the second CNT layer 204b. Incidentally, the first and second binder layers 203a, 203b and the first and second CNT layers 204a, 204b are formed by the screen printing method or the spray method. That is, the CNTs produced as described above are dispersed into a solution such as ethanol and then deposited on the conductive layer 205 by a screen printing or a spraying technique or the like.

The screen printing or the spraying technique or the like is used because their processes are simpler and they are more suitable for large areas when compared with the transfer method or the CVD method. Incidentally, CNTs can be adhered onto the first and second binder layers 203a, 203b in the form of powder, in the case of which the flatness and uniformity of the film is slightly degraded.

It is possible to employ resist, SOG (Spin on glass), or resin such as acrylic or the like for the first and second binder layers 203a, 203b. For the first and second CNT layers 204a, 204b, used was the suspension having CNTs ultrasonically dispersed in a solution such as ethanol having a low viscosity and a high volatility. The effects of the present invention can be more easily obtained with a higher CNT concentration in the suspension, and the CNTs were here adjusted to a concentration of two grams per liter or more in ethanol.

As shown in FIG. 6, in the cross section of the CNT layer 201 having the first and second CNT layers 204a, 204b, the first and second binder layers 203a, 203b and the first and second CNT layers 204a, 204b are not completely separated, such that the first and second CNT layers 204a, 204b are slightly impregnated with the first and second binder layers 203a, 203b. This is because the first and second CNT layers 204a, 204b were stacked immediately before the first and second binder layers 203a, 203b were hardened. Furthermore, it was confirmed by a scanning electron microscope and a transmission electron microscope that most of the second CNT layer 204b near the surface were aligned generally vertically relative to the glass substrate 206 and had a clean surface.

As described above, the factor that the surface CNTs or the second CNT layer 204b are clean and readily aligned upright results from the fact that the surface CNT are hardly affected by the binder material and a CNT suspension of a high concentration is used. Here, the “upright alignment” means the state in which the tip portion of the CNTs in the CNT layer is aligned at an angle of 50 degrees or less relative to the normal to the glass substrate 206. Incidentally, although the upright alignment is enhanced due to an electrostatic force resulting from the application of an electric field, the upright alignment as referred to herein is a state after the enhancement.

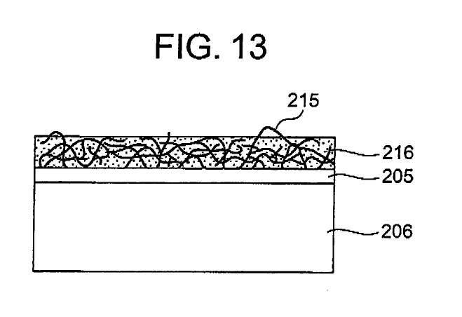

In the CNT layer (see FIG. 13) formed using a conventional technique, i.e., using a liquid mixture having a binder and CNTs mixed therein, since CNTs are soaked in the binder before deposition, the CNTs are readily aligned in parallel to the surface of the binder liquid due to the surface tension of the binder, allowing the CNT surface to be coated with the binder. In contrast to this, when the films of the binder and the CNTs are each independently formed as in this embodiment, the CNT surface will never be directly affected by the binder and can maintain a clean surface. Furthermore, since a suspension of a high CNT concentration with CNTs dispersed in a solution having a high volatility and a low viscosity upon forming the CNT layer is used to cause the solution to evaporate soon after the film is formed, and the surface tension of the solution hardly exerts an effect, the CNTs aligned upright relative to the glass substrate 206 can remain unchanged.

Furthermore, upon forming the CNT film, the substrate can be heated, thereby further accelerating the evaporation of the solution. Although the temperature of the substrate needs to be set at a temperature at which the solution readily evaporates, excessively high temperatures would cause the binder layer to be baked, thereby making the effects of the present invention to be hardly obtained. That is, the binder layer would harden before the CNT layer is formed, thereby inhibiting the impregnation of the CNT layer with the binder as described below. In the case where the solution in the CNT suspension is ethanol, it is possible to realize sufficient effects by heating up to about 80 degrees to 100 degrees.

The adhesiveness between the CNT layer 201, the conductive layer 205, and the glass substrate 206 was high, and no peeling of the CNT layer was found, for example, when a peeling test was performed with an adhesive tape having an adhesion of 1N/20 mm. Such a strong adhesiveness arises because the first and second CNT layers 204a, 204b configured to be impregnated with the first and second binder layers 203a, 203b as described above, thereby allowing the binder layer to positively secure the neighboring CNT layer. On the other hand, the fact that the CNTs themselves have a high degree of flexibility to be easily tangled with each other is also one of the factors to enhance the adhesiveness.

Furthermore, a peeling test performed with a highly adhesive tape showed local peeling of the CNTs, however, since the CNT layer 201 had a stacked structure, the peeled portion of the first CNT layer 204a allows its underlying layer or the second CNT layer 204b to appear. As described above, the stacked structure of CNTs allows the CNTs in the underlying layer to appear on the surface and serve as new electron sources even when the film is damaged, thus having an advantage that the characteristics hardly deteriorate. In FIG. 6, such an example was described in which the stacked structure of the CNT layer and the binder layer is successively stacked twice, however, the stacked structure may also be stacked only once or more than twice.

The greater the number of stacks, the higher the stability of the characteristics against damage becomes.

The respective thicknesses of the first and second binder layers 203a, 203b upon forming the CNT layer 201 are suitably 0.01 to 1 μm. Since the CNT layer 201 and the conductive layer 205 are completely separated with each of the first and second binder layers 203a, 203b greater than 1 μm, an electrical communication between the CNT layer 201 and the conductive layer 205 is cut off. Therefore, to reduce the contact resistance between the second CNT layer 204b and the conductive layer 205, it is necessary to set the thickness of each of the first and second binder layers 203a, 203b at 1 μm or less.

However, the first and second binder layers 203a, 203b can be made thinner with limitation. For example, by the screen printing method or the spray method, a thickness of below 0.01 μm makes it difficult to form a binder layer uniformly on the CNT layer. For this reason, in practice, each of the first and second binder layers 203a, 203b are desirably 0.01 μm or more. Furthermore, controlling the thicknesses of the first and second binder layers 203a, 203b particularly within the range of 0.1 to 0.5 μm of the range would make it possible to further reduce variations in characteristics and provide improved yields. On the other hand, to further reduce the contact resistance between the second CNT layer 204b on the surface side and the conductive layer 205, it is possible to add conductive fine particles to the first and second binder layers 203a, 203b.

On the other hand, the respective thicknesses of the first and second CNT layers 204a, 204b are suitably 0.1 to 5 μm. The CNT layer 201 needs to be set on the surface at an optimum thickness which allows not to be affected by the binder layers 203a, 203b while maintaining adhesiveness with a slight seepage of the underlying binder layers 203a, 203b. Since the binder penetrates into the surface of the CNT layer with each of the first and second CNT layers 204a, 204b being below 0.1 μm in thickness, the effects of the present invention are hardly obtained.

Conversely, on the other hand, the surface CNTs are easily peeled off because more regions would not be affected by the binder with each of the first and second CNT layers 204a, 204b being above 5 μm in thickness. Accordingly, it is desirable to control the thickness of the CNT layer at 0.5 μm to 5 μm. Controlling the thickness of each of the first and second CNT layers 204a, 204b particularly within the range of 0.5 to 1 μL m of the range would make it possible to further reduce variations in characteristics and provide improved yields.

FIG. 7 shows the results of measurements of emission current densities with an anode electrode disposed on the stacked CNT layer with a vacuum gap interposed therebetween, as described with reference to FIG. 6. The vertical axis shows the emission current density and the horizontal axis shows the electric field strength obtained by dividing the voltage applied to the anode by the vacuum gap, respectively. The emission current starts to rise at a low electric field of 1V/μm, showing a current density of 10⁻⁴A/cm² at 1.7 V/μm. Furthermore, the current was highly stable during the application of voltages, and no damage was found on the surface of the stacked CNT layer after the application of the voltages.

Sixth Embodiment

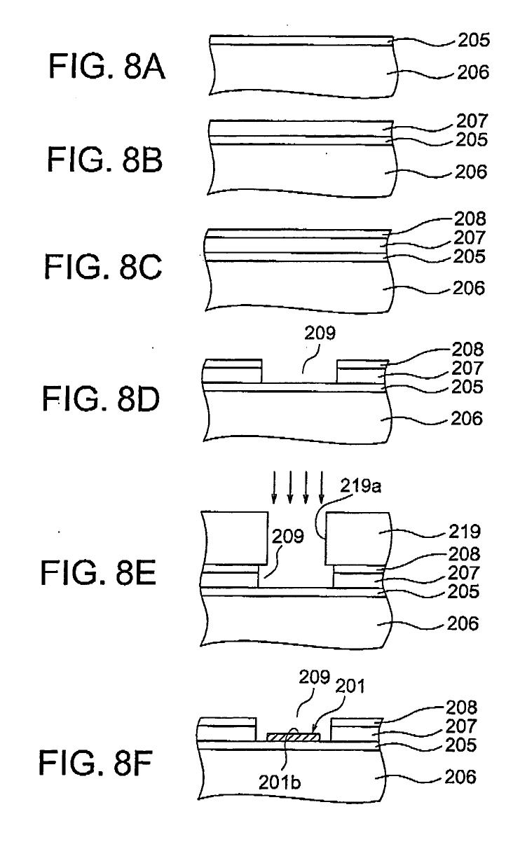

FIG. 8A to FIG. 8F sequentially illustrate the process steps of a method according to a sixth embodiment of the present invention. The method according to this embodiment and the method according to the fifth embodiment are largely different in whether the CNT layer 201, which is a stacked film, is formed before or after the insulating layer and the gate electrode layer are formed.

That is, in this embodiment, as shown in FIG. 8A, the conductive layer 205 is formed on the glass substrate 206, and then as shown in FIG. 8B, the gate insulating layer 207 of silicon oxide film or polyimide film or the like is deposited in a thickness of 20 μm on the conductive layer 205. Then, as shown in FIG. 8C, aluminum is formed in a thickness of 0.5 μm on the gate insulating layer 207 as the gate electrode layers 208. Additionally, as shown in FIG. 8D, part of the gate electrode layers 208 and the gate insulating layer 207 is removed by etching to form the gate openings 209.

Subsequently, as shown in FIG. 8E, the gate electrode layers 208 are covered thereon with a mask material 219 excluding the gate openings 209 and a binder material and CNTs are sprayed in this order on the mask material 219, thereby forming the CNT layer 201 on the conductive layer 205 via openings 219a of the mask material 219 and the gate openings 209. After the previous CNT layer is formed, the next CNT layer is stacked thereon, thereby forming the same stacked CNT layer 201 as the one shown in the fourth embodiment. Thereafter, as shown in FIG. 8F, the mask material 219 is removed, thereby providing a field emission cold cathode of a triode structure which employs the CNT layer 201 as an emitter 201b.

As the mask material 219, it is possible to employ a thin film which is patterned by applying resist or the like so as to cover other than the gate openings 209, a metal mask obtained by drilling a metal plate, or the like. However, when a patterned resist or the like is employed, the mask material 219 has to be finally removed with a remover liquid and part of the mask material may adhere to the CNT surface, thus requiring a sufficient cleaning.

In contrast to this, since the metal mask has only to be mechanically fixed such that the gate openings 209 and the openings of the mask are aligned with each others there will not be raised such a drawback that the CNT surface is contaminated in the course of removing the mask material. Incidentally, a like step of retrofitting CNTs is also described in Japanese Patent Application No. Hei 11-145900. The description tells that CNTs are deposited on the entire surface without using a mask material and thereafter etched by oxygen plasma such that the CNTs remain only in the gate opening. However, since the CNTs aligned upright on the CNT surface are progressively etched on a priority basis in oxygen plasma, the upright aligned CNTs that are finally obtained are extremely less than those obtained according to the present invention.

Upon spraying CNTs using a mask material, when CNTs adhere to the sidewall of the gate insulating layer 207 surrounding inside the gate opening 209 due to the spread, recoil or the like of the CNT particles inside the gate opening, a leakage current may occur between the emitter 201b (FIG. 8F) and the gate electrode layers 208. Since an increase in the leakage current may possibly induce damage to the element, the leakage current needs to be reduced. As a method for reducing the leakage current, the openings 219a of the mask material 219 are made smaller in diameter than the gate openings 209 as shown in FIG. 8E, while the mask material 219 is formed thicker to increase its aspect ratio, thereby making it possible to ensure the directivity of CNT particles and prevent the CNTs from adhering to the inner wall surface of the gate insulating layer 207.

This embodiment employed the mask material 219 having an 80% opening diameter relative to the diameter of the gate openings 209. Employing the mask material 219 having an opening diameter of 80% or more may cause the CNTs to adhere more frequently to the inner wall surface of the gate insulating layer 207 inside the gate openings 209, leading to a higher possibility of damage occurring at the time of activation. Furthermore, employing a mask material having an extremely small opening diameter may reduce gate leakage but reduce the area of the emitter 201b, making it impossible to obtain sufficient emission current. Therefore, the opening diameter of about 80% is optimal.

On the other hand, the mask material 219 is formed so as to satisfy

t/d>1,

where d is the diameter of an opening 217a of the mask material 219 and t is its thickness. This makes it possible to prevent CNTs from adhering to the inner wall surface of the gate insulating layer 207 and reduce the leakage current. Conversely, for t/d<1, more CNTs adhere to the inner wall surface of the gate insulating layer 207 inside the gate openings 209, thereby causing damage to occur locally at the time of activation. Incidentally, such a case was described here where the opening of the mask material 219 is the same in shape as the gate openings 209, however, without being limited thereto, the openings of the mask material 219 may have the shape of an ellipse or a polygon such as a square or a rectangle.

On the other hand, upon forming a CNT film by bringing a metal mask or the like into mechanical contact with the top of the gate electrode, the capillary phenomenon may cause a CNT suspension and a binder to penetrate into between the metal mask and the gate electrode. In this case, as described above, the substrate can be heated to accelerate the evaporation of the solution and thereby reduce the surface tension, thus suppressing the capillary phenomenon.

Modification of Sixth Embodiment

As shown in FIG. 9, instead of the gate insulating layer 207, a first insulating layer 217 and a second insulating layer 218 are stacked in this order on the conductive layer 205, and the opening 217a of the first insulating layer 217 is formed larger in diameter than an opening 218a of the second insulating layer 218, thereby making it possible to produce a shielding effect and reduce leakage current. Each of the first and insulating layers 10, 11 was set at a thickness of 10 μm, however, the thickness can be set freely.

On the other hand, as shown in FIG. 10, for the insulating layer formed in one layer, the central portion of an opening 207a of the gate insulating layer 207 can be expanded, thereby providing for the same shielding effect as that in the case of FIG. 9. Not only the central portion but also the diameter of the entire region of the inner wall surface of the opening 207a in the gate insulating layer 207 can be made larger than the gate opening diameter, thereby producing the shielding effect. However, in this case, most of the electrons emitted from the emitter 201b jump into the gate electrode 209, thereby causing the emission efficiency to be slightly reduced.

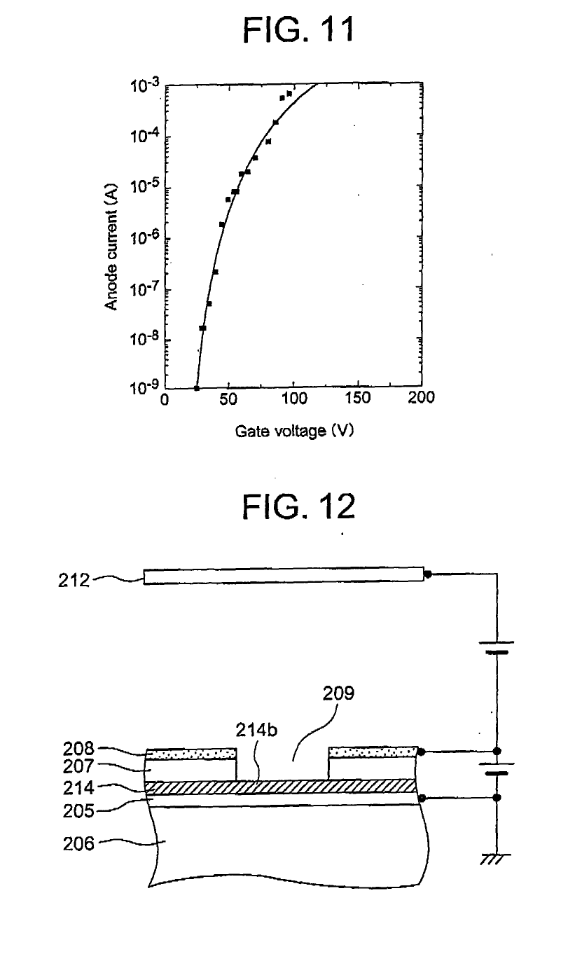

FIG. 11 is a graph showing the emission characteristics of a field emission cold cathode fabricated according to the methods of the fifth and sixth embodiments. The vertical axis shows the amount of anode current flowing into the anode electrode that is spaced via a vacuum from the gate electrode, while the horizontal axis shows the potential difference between the emitter and the gate electrode. Electron emission rises at a low voltage of 25V and indicates a current value of 1 mA at 100V.

In the method shown in the fifth embodiment, i.e., the method for first forming the CNT layer 201 in the stacked structure, since the overlying gate insulating layer 207 and gate electrode layers 208 have to be removed in the subsequent process, their residues may remain on the surface of the CNT layer 201 to cause deterioration in characteristics. Accordingly, when good characteristics cannot be obtained due to a large amount of residues remaining on the surface of the CNT layer 201, it is also possible to fabricate a field emission cold cathode according to the fifth embodiment and thereafter re-form the CNT layer 201 according to the technique described in the sixth embodiment.

To form a stacked structure according to the second and third aspects of the present invention, applying the patterning method according to the first aspect provides the following effects.

In the CNT film 201 having the stacked structure according to the second and third aspects of the present invention, i.e., the stacked structure including the successively stacked binder layer and CNT layer containing CNTs bonded by the binder layer, in the CNT film 201 having two or more of the stacked structure stacked successively, or in the CNT film 201 having the binder layer set to a thickness of 0.01 to 1 μm and the CNT layer set to a thickness of 0.1 to 5 μm, respectively (hereinafter referred to as the CNT film according to the fifth aspect of the present invention), the surface of the film is uniform and the film itself is robust, thereby making it possible to provide a thinner film without being peeled off even with its thickness reduced.

In contrast to this, the conventional single-layer film has a nonuniform surface with the film itself being brittle, thereby causing peeling to readily occur and making it difficult to provide a thinner film.

Accordingly, when compared with the prior art, the CNT film according to the fifth aspect of the present invention, on which a metal film such as an etching mask, an insulating film or the like is formed, would allow a uniform thin film having an excellent covering property to be formed thereon.

When the CNT film 201 having such a stacked structure according to the present invention is patterned by utilizing a pattern mask made of, e.g., a metal film, it is possible to provide more uniform emission because even pressing a hard metal mask against this robust CNT film causes less scratches and damage to the surface resulting from mechanical friction.

Furthermore, when a metal film serving as a mask is uniformly deposited on the CNT film 201, fine pinholes are hardly created.

Therefore, removing part of the CNT film for use in a display or the like by using a dry etching method will eliminate deterioration of the CNTs due to gases which would otherwise pass through the pinholes, thereby reducing nonuniform emission and providing a film of improved uniformity.

Furthermore, the CNT film 201 according to the fifth aspect of the present invention can be readily made thinner, which in turn makes the etching time shorter, thereby making it possible to shorten the process time and realize high throughput. Even in the presence of pinholes resulting from insufficient protection of the metal film used for an etching mask, this shortens the time for etching the CNTs in the pinhole portions and thus reduces damage resulting from the etching, thereby suppressing nonuniform emission.

Furthermore, the CNT film according to the fifth aspect of the present invention is extremely advantageous from the viewpoint of removing a catalytic metal used in the CNT fabrication process. In the case of the prior art thick CNT film and particularly when it contains a catalytic metal, lifting off is required after etching to remove residual catalytic metal. In contrast to this, the CNT film 201 according to the fifth aspect of the present invention provides only a trace amount of residual catalytic metal when it remains, making it possible to remove it by washing in water or the like. Accordingly, it is possible to eliminate the lifting-off step even when CNTs refined to a low degree are used. That is, it is possible to eliminate or simplify the refinery process of CNTs or the lifting-off step after patterning, thereby reducing costs.

As described above, although the present invention was described in accordance with the preferred embodiments, the field emission cold cathode according to the present invention and its fabrication method and the flat image display device are not limited only to the configurations of the embodiments, but a field emission cold cathode and its fabrication method and a flat image display device, to which various modifications and changes are made to the configurations of the embodiments, are also included within the scope of the present invention.

1. A method for patterning carbon nanotubes by removing the carbon nanotubes via a mask formed in a predetermined pattern, the carbon nanotubes being adhered to a substrate or a substrate having a thin film coated on at least part of a surface thereof, the carbon nanotubes containing a binder and tangled with each other, said method characterized by using a solution for dissolving said binder to remove the carbon nanotubes, and rubbing off said tangled carbon nanotubes.

2. The method for patterning carbon nanotubes according to claim 1, wherein said removing the carbon nanotubes and said rubbing off the carbon nanotubes with the cloth-like substance are performed by dampening a cloth-like substance with the solution used for the removal and rubbing the carbon nanotubes with said cloth-like substance.

3. The method for patterning carbon nanotubes according to claim 1 or 2, wherein the mask is made of metal, glass, or ceramic.

4. The method for patterning carbon nanotubes according to any one of claims 1 to 3, wherein the carbon nanotubes are nanotubes containing nanoparticles.

5. A method for patterning carbon nanotubes by removing through a first dry etching method part of the carbon nanotubes adhered to a substrate or a substrate having a thin film coated on at least part of a surface thereof, characterized by:
using, as a mask for patterning the carbon nanotubes, a metal film or a film made of a substance resistant to damage upon said first dry etching and scarcely causing damage to the carbon nanotubes upon removing said mask.

6. The method for patterning carbon nanotubes according to claim 5, wherein said first dry etching method is a method of burning in an oxygen ambient.

7. The method for patterning carbon nanotubes according to claim 5 or 6, wherein the metal film is an aluminum film, a titanium film, a gold film, a molybdenum film, a tungsten film, or a silver film.

8. The method for patterning carbon nanotubes according to claim 5 or 6, wherein the film made of the substance resistant to damage upon said first dry etching and scarcely causing damage to the carbon nanotubes upon removal is a silicon dioxide film or an aluminum oxide film.

9. The method for patterning carbon nanotubes according to any one of claims 5 to 8, wherein the carbon nanotubes are single wall nanotubes or multi-wall nanotubes.

10. The method for patterning carbon nanotubes according to claim 9, wherein the single-wall nanotubes or the multi-wall nanotubes are refined nanotubes having nanoparticles removed.

11. The method for patterning carbon nanotubes according to any one of claims 1 to 9, wherein the carbon nanotubes are nanotubes containing nanoparticles, and nanoparticles remaining between patterns of the carbon nanotubes are removed by lifting off at least part of the thin film.

12. The method for patterning carbon nanotubes according to any one of claims 5 to 9, wherein the carbon nanotubes are nanotubes containing nanoparticles and the nanoparticles remaining between the patterns of the carbon nanotubes are removed by a second dry etching method different from said first dry etching method.

13. The method for patterning carbon nanotubes according to claim 12, wherein said second dry etching method is any one of sputtering etching, chemical etching, reactive etching, reactive sputtering etching, ion beam etching, and reactive ion beam etching, and removes a catalytic metal constituting at least part of said nanoparticles.

14. The method for patterning carbon nanotubes according to any one of claims 1 to 13, wherein a carbon nanotube film is formed by a screen printing method, a spray method, or a transfer method.

15. A field emission cold cathode comprising an emitter having a carbon nanotube pattern formed by the method according to any of claims 1 to 14, and allowing a predetermined voltage to be applied to said emitter and to emit electrons from a surface of said emitter, characterized in that:
said emitter has a stacked structure made of a successively stacked binder layer and a CNT layer containing CNTs bonded by said binder layer.

16. Afield emission cold cathode comprising an emitter formed on a substrate and containing a plurality of carbon nanotubes (CNTs), and allowing a predetermined voltage to be applied to said emitter and to emit electrons from a surface of said emitter, characterized in that:
said emitter has a stacked structure made of a successively stacked binder layer and a CNT layer containing CNTs bonded by said binder layer.

17. The field emission cold cathode according to claim 16, wherein two or more of said stacked structure are stacked successively.

18. The field emission cold cathode according to claim 16 or 17, wherein a gate insulating layer and a gate electrode-layer are formed in this order on said CNT layer, a surface of said CNT layer is exposed from an opening penetrating both said gate electrode layer and said gate insulating layer, and different voltages are respectively applied to said gate electrode layer and said emitter.

19. The field emission cold cathode according to any one of claims 16 to 18, wherein said binder layer is set to a thickness of 0.01 to 1**, and said CNT layer is set to a thickness of 0.1 to 5**, respectively.

20. A flat image display device characterized by the field emission cold cathode according to any one of claims 16 to 119.

21. A method for fabricating a field emission cold cathode characterized by the steps of:
forming a conductive layer on a substrate and forming a stacked CNT layer by stacking a binder layer and a CNT layer containing a plurality of carbon nanotubes (CNTs) in this order on said conductive layer;
forming a gate insulating layer and a gate electrode layer in this order on said stacked CNT layer; and
forming an opening by removing said gate electrode layer and said gate insulating layer by etching to expose a surface of said stacked CNT layer within said opening.

22. The method for fabricating a field emission cold cathode according to claim 21, wherein the step of forming said stacked CNT layer is performed twice or more successively.

23. The method for fabricating a field emission cold cathode according to claim 21 or 22, further comprising the step of baking said CNT layer and said binder layer prior to the step of forming said gate insulating layer and said gate electrode layer.

24. The method for fabricating a field emission cold cathode according to any of claims 21 to 23, further comprising the step of:
upon patterning by removing said CNT layer via a mask patter, removing said CNT layer using a solution for dissolving said binder layer and rubbing off carbon nanotubes tangled with each other in said CNT layer.

25. A method for fabricating a field emission cold cathode characterized by the steps of:
forming a conductive layer on a substrate;
forming a gate insulating layer and a gate electrode layer successively on said conductive layer;
removing said gate electrode layer and said gate insulating layer by etching to form an opening and exposing said conductive layer within said opening; and
covering said gate electrode layer excluding said opening with a mask material and spraying a binder material and carbon nanotubes (CNTs) in that order onto said conductive layer through said mask material and said opening to form a stacked CNT layer.

26. The method for fabricating a field emission cold cathode according to claim 25, wherein the step of forming said stacked CNT layer is performed twice or more successively.

27. The method for fabricating a field emission cold cathode according to claim 25 or 26, wherein said gate insulating layer comprises a first insulating layer and a second insulating layer each having an opening and stacked successively, and the opening of said first insulating layer is formed to be larger in diameter than the opening of said gate electrode layer.

28. The method for fabricating a field emission cold cathode according to any one of claims 25 to 27, wherein the opening of said mask material is formed to be smaller in diameter than the opening of said gate insulating layer.

29. The method for fabricating a field emission cold cathode according to any one of claims 25 to 28, wherein said mask material is formed to satisfy the following equation:
t/d>1,
where d is a diameter of the opening of said mask material and t is a thickness of said mask material.

30. The method for fabricating a field emission cold cathode according to any one of claims 21 to 29, wherein a temperature of the substrate is increased upon forming said CNT layer.
